(19) United States
(12) Patent Application Publication
(10) Pub. No.: US 2019/0257285 A1
(43) Pub. Date: Aug. 22, 2019

(54) ARCHED RIB FOR A TURBINE

(71) Applicants: Windside America Ltd., Saint Paul, MN (US); Oy Windside Production Ltd, Viitasaari (FI)

(72) Inventor: Risto Joutsiniemi, Viitasaari (FI)

(21) Appl. No.: 15/899,181

(22) Filed: Feb. 19, 2018

(51) Int. Cl. F03D 3/06

(52) U.S. Cl. CPC F03D 3/064; F03D 3/065; F05B 2280/6003; F05B 2230/20; F05B 2240/213

(57) ABSTRACT

A rotor having at least two vanes includes a plurality of elongated arched support ribs rigidly connecting at axially spaced intervals to a shaft of the turbine. The arched support ribs are disposed transverse to the shaft and provide a mating face to connect to the entire inner face of the vane. A method of forming the rib is further included.

### FIELD OF THE INVENTION

The present invention relates to fluid operated turbines. More particularly, the present invention relates to an arched rib design for fluid operated turbines integrated into a linear power station.

### BACKGROUND OF THE INVENTION

Known wind turbines typically have a rotatable central hub coupled to a plurality of radially mounted blades much like the propeller of a propeller driven aircraft. Such blades travel in a generally vertical arc with the hub. The blades rotate at speeds sufficient to generate a desired amount of electrical power.

There are a number of shortcomings with turbines of the design frequently found in the prior art. The power generation requirements result in a relatively high tip speed of the blades. The high tip speed generates undesirable noise that has been associated with health issues.

The wind turbines described above are additionally not omni-directional. Such wind turbines must be faired into the prevailing wind, usually by generally rotating the hub and propeller horizontally on the supporting mast, in order to capture the energy of the prevailing wind. The volume of space required for the operation of such turbines is at least the blade tip-to-tip distance in both the vertical and horizontal directions. This is a considerable and undesirably large volume, especially for use in inhabited areas. The radial disposition of the blades relative to the hub requires that a significant volume be dedicated to the wind turbine. When attempting to integrate a non-vertical (or propeller type) wind turbine with a human occupied building, such dedicated volume detracts from the usefulness of the non-vertical wind turbine and adversely affects the building design.

The use of wind turbine structures to generate power are also disclosed in the PCT Publication W/O 81/01443, Canadian Patent 1,236,030, and U.S. Pat. No. 8,087,897, which are incorporated herein by reference Such prior art device comprise:
a base;
a frame pivotably connected to the base;
a rotor comprising a pair of elongated flightings or vanes having an outer and an inner edge and a curved, e.g., semicircular, cross-section and arranged in an axial direction about a geometrical axis in a symmetrical fashion such that the concave sides of the flightings partially overlap each other, defining an axial passage between the inner edges of the flightings, the flightings being twisted in a screw-shaped manner in relation to one another;
a longitudinal element connecting at least one end of the rotor to a frame in a pivotable manner; and
a plurality of elongated, generally airfoil-like ribs rigidly interconnecting, at axially spaced intervals, the outer edge of each flighting with the inner edge of the other flightings, said ribs being arranged in a substantially perpendicular relationship to the geometrical axis, and the cross-sectional of the ribs being convex in one and same direction of the geometrical axis.

The prior art rotor only allows for limited connections between the vanes and the ribs. Thus the vanes are subjected to localized stresses at the point of connection. In the prior “Flat Bar Rib” design, the force caused by the vane is partitioned only as to both ends of the rib.

There is a need then in the industry for a relatively quiet wind turbine couplable into a linear power station that generates no potential health issues with its rotation and that does not adversely affect the local bird population. Additionally, there is a need for an omni-directional wind turbine in a linear power station that need not be faired into the prevailing fluid flow in order to effect rotation thereof. Further, there is a need for an improved rib design so as to more efficiently connect the vanes to the rotor.

### SUMMARY OF THE INVENTION

The present invention provides a rotor of the above type with spaced arched-shaped support ribs and including balancing and connecting masses, so that particularly advantageous balancing conditions within the rotor are achieved.

The turbine is designed to maximize the conversion of kinetic energy in the wind at all wind speeds. The electricity can be generated from wind speeds as low as 2 m/s and from wind speeds as high as 60 m/s. The energy from turbulent wind is also harnessed due to the double helix shape of the present invention as the wind is always at the right angle for the turbine vanes.

The turbine is mainly used for the purpose of charging DC battery banks of 12 V, 24 V or 48V batteries. The stored energy can then be used to power DC instruments, lights, signals, and system with or without a grid connected alternative. Furthermore, the present invention improves the fastening of the vanes so as to make it easier to grow the size of this kind of turbine to very big AC-generating turbines for producing power into the public grid.

The rotor, according to the invention, is mainly characterized by a plurality of elongated, generally arched support ribs, rigidly interconnecting at axially spaced intervals to each flighting or vane. The arched ribs may be positioned transverse to the shaft. Said ribs are arranged in a substantially perpendicular relationship to the geometric axis. The cross-section of the arched ribs may be convex in one and the same direction of the geometrical axis. The ribs may have a connecting boss at the distal end and an intermediate balancing mass.

The present invention is a rotor with an improved fastening method which connects or fastens the vanes of the turbine firmly and safely to the turbine shaft. In earlier fastenings, as disclosed in U.S. Pat. No. 8,087,897 B2 and WO 81/01443, the vanes were fastened only from the end of the fastening or rib and from the middle point of the fastening. Now, this new type of fastening makes it possible to fasten the vane material all the way along its radius direction.

The fastening or rib generally includes a hub section for connection to a rotor shaft, and opposing ribs that extend distally from the hub. The arched rib sections are made in the shape of a bow, a curve, or an arc, which is carefully designed to follow the form of the curved vane. This same form shared between the bow, curve, or arc, and the vane itself enables attaching the vane material across the whole surface of the fastenings curve.

In the prior “Flat Bar Rib” design, the force caused by the vane is partitioned only as to both ends of the rib. In the present invention, the force is spread about the entire mating face of the fastening or rib. When the vane has been fastened in the radius direction, the new invention multiplies the firmness of the vane related to the shaft. The new type of fastening moves those forces, more efficiently to the shaft than the old type of rib, which was a “flat bar rib” where the vane was only connected at the edges of the vane.

In the present invention, the curved rib can be attached to the vane along the whole length of the fastening curve, for instance with glue and/or with screws of 10-100 pc or more. This new fastening type and method is much stronger than earlier fastening model and method, where the vane is in the radial direction fastened only with two or four screws.

The present invention is a rotor having at least two flightings or vanes and including a plurality of elongated support ribs rigidly interconnecting at axially spaced intervals, the outer edge of a first flighting with the inner edge of the other flighting. The arched ribs may be connected to the vane of flighting at other points along the inner edge. The arched ribs may have a connecting boss at a central hub. A balancing mass may be positioned intermediate a proximal end and the distal end of the arched rib.

The present invention is a rotor having a vane and including a plurality of arched support ribs rigidly interconnecting at axially spaced intervals along a shaft; each arched support rib including a hub section and an arcuate wing section, the hub section defining a connecting boss for connection to the shaft. The arcuate wing section includes a curved arm and a mounting arm. The vane is mounted along an outer perimeter of the curved arm. The vanes are glued, screwed or connected in any reasonable manner depending on the types of material used in the vanes and the ribs to the outer perimeter of the curved arm. The connecting boss may include a threaded bore. In a preferred embodiment the rotor includes at least two vanes.

The present invention also includes a method for mounting a vane to a rotor. The method comprising connecting a rib assembly transverse to a shaft. The rib assembly having a central hub defining an opening for engaging the shaft, a rib arm extending radially from the hub and a rib arched wing connecting a distal end of the rib arm with the hub, and fastening an interior face of the vane to a mating face of the rib arched arm. Fastening the vanes to the ribs is by glue, screws or other fastening techniques appropriate for the materials used. The rib assembly may further include opposing rib arms extending distally from the central hub.

One advantage to the present invention is that the rib arm may be made of a material different from a material forming the rib arched wing and different from the central hub.

The rotor, according to the invention, will be examined in more detail, reference being made to the attached drawings.

### BRIEF DESCRIPTION OF THE DRAWINGS

FIG. 1 is an elevational view of a wind turbine;

FIG. 2 is a perspective view of a wind turbine section illustrating the fastenings of the present invention;

FIG. 3 is a perspective view of a rib of the present invention;

FIG. 4 is a top perspective view of an alternate embodiment of a Fastening Rib for a Turbine;

FIG. 5 is a top plan view of the Fastening Rib depicted in FIG. 4;

FIG. 6 is a front side elevational view of the Fastening Rib depicted in FIG. 4;

FIG. 7 is a bottom plan view of the Fastening Rib depicted in FIG. 4;

FIG. 8 is a rear side elevational view of the Fastening Rib depicted in FIG. 4;

FIG. 9 is a left side elevational view of the Fastening Rib depicted in FIG. 4; and

FIG. 10 is a right side elevational view of the Fastening Rib depicted in FIG. 4.

### DETAILED DESCRIPTION OF THE DRAWINGS

The rotor of the present invention is depicted generally in FIG. 1. The rotor 1 according to the invention comprises a pair of elongated flightings or vanes 2a, 2b having a curved, preferably semi-circular, cross section. In this application, flighting and vanes are used interchangeably as are fastenings and ribs.

The flightings 2a, 2b are arranged axially about a longitudinal, geometrical axis 5 (see FIG. 1) in a symmetrical fashion such that the concave sides of the flightings 2a, 2b partially overlap each other. Thereby an axial passage is defined between the inner edges of the flightings 2a, 2b. The flightings 2a, 2b are twisted in a screw-shaped manner in relation to one another by substantially 180°. The length of the rotor 1 is preferably at least four times its diameter.

A longitudinal shaft 3 is connected at least at one end to a supporting frame 50 in a rotatable manner. The shaft 3 is concentric with the axis 5. As discussed above, the connection may also be pivotable. In that case means are provided for resiliently keeping the rotor 1 in a first axial direction in relation to a supporting frame but allowing the rotor 1 to pivot as a function of the wind strength influencing the rotor 1.

A plurality of elongated, generally arched-like support ribs 4, rigidly interconnect, at preferably axially equidistant intervals, the inner face of each of the respective flightings 2a, 2b. As illustrated in FIG. 1, the flightings 2a, 2b wrap around the shaft 3. The support ribs 4 can be transverse to the shaft 3 or at angles greater or less than ninety degrees.

Said ribs 4 are arranged in a substantially perpendicular relationship to the longitudinal axis 5 and their cross section is convex in the upper direction with respect to a vertically mounted rotor 1. The shaft 3 may extend over the whole axial length of the rotor 1 as is the case in FIG. 1.

The arched rib of the rotor 1 is shown generally at 4 in FIGS. 1 and 3. The arched rib 4 is formed of two major subcomponents; the hub 10 and blade 30.

The hub 10 of the rib 4 includes a hub body 12. An axial bore 14 is defined in the hub body 12. The axial bore 14 is defined coaxially with the longitudinal axis 5 of the rotor 1.

A pair of threaded bores 18 penetrate the hub body 12 and intersect the axial bore 14. When the rib 4 is disposed on the shaft 3, bolts (not shown) may be threadedly disposed in the respective threaded bores 18, the end of the respective bolts bearing on the exterior margin of the shaft 3 to fixedly couple the rib 4 to the shaft 3.

A pair of opposed flighting inner edge supports 20 are preferably formed integral with the hub body 12. Each of the flighting inner edge supports 20 includes an angled support face 21. A blind threaded bore 22 commences at each respective support phase 21 and extends inward into the respective flighting inner edge supports 20.

A selectable balancing mass 24 may be formed integral with the flighting inner edge support 20. The selectable balancing mass 24 preferably extends radially from the hub body 12. As depicted in FIG. 3, the selectable balancing mass 24 has an inner margin 26 and an outer margin 28. The distance between the inner margin 26 and the outer margin 28 may be varied as desired to suitably affect the mass of selectable balancing mass 24. Other known means may be utilized to affect such mass, such as varying of the exterior margin 29 of the balancing mass 24 and forming the balancing mass 24 of a material having a greater or less mass as desired, for example.

The blade 30 extends radially outward from the hub 10 and is coupled to the selectable balancing mass 24 at the proximal end 32 of the blade 30. A coupling boss 36 is formed at the distal end 34 of the blade 30. The coupling boss 36 presents a flighting outer edge support face 42 having a blind threaded bore 38 defined therein.

The blade 30 may include opposing arcuate wings 39 and 40 that connect to the rib 4 at a first end 41 approximate the inner edge support 20 at a second end at the flighting outer edge support face 42 proximate the distal end 34. The arcuate wings 39 and 40 maybe of a single piece or be constructed of multiple segments. The arcuate wings 39 and 40 allow for additional surface area in which to connect to the vane or flighting. The arcuate wings 39 and 40 have an outer face 43 that may be flat or contain connections for attaching the vanes. An inner region 44 is defined by the blade 30 and the arcuate wings 39 and 40. The inner region 44 may be open or may filled with other support structure.

The ribs 4 are preferably made of metal, whereas the flightings 2a, 2b can be made of metal or plastic. Other combinations of materials may be used or the ribs and flightings could be made of the same material.

The selectable balancing mass 24 of the hub 10 is selected to suitably balance the rotating mass of the rotor 1. Such balancing takes into account the effects of the mass of the shaft 3, the flighting 2, and the rib 4 itself for a known range of rotational velocities to be experienced by the rotor 1. Further, the mass of the selectable balancing mass 24 is selected such that the resonant frequency of the rotor 1 lies either below or above the range of rotational velocities to be experienced by the rotor 1. Avoiding operation of the rotor 1 in the vicinity of its natural frequency is critical to minimizing potentially destructive resonances in the rotating rotor 1.

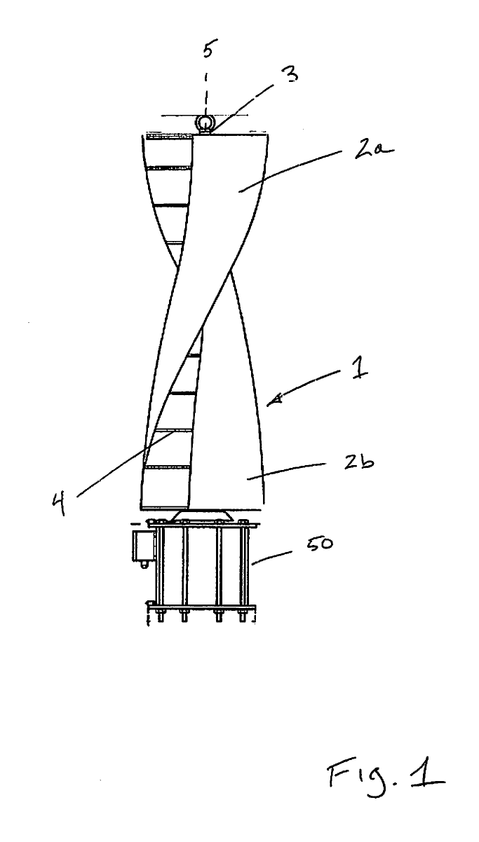

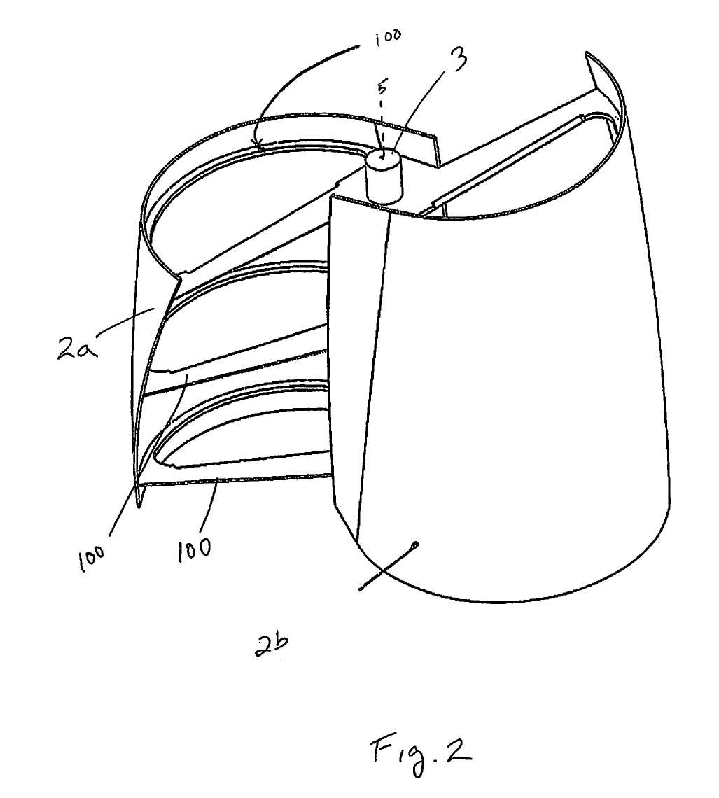

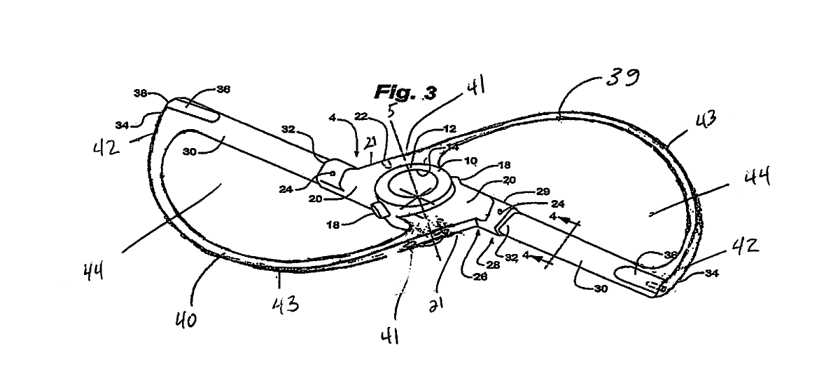

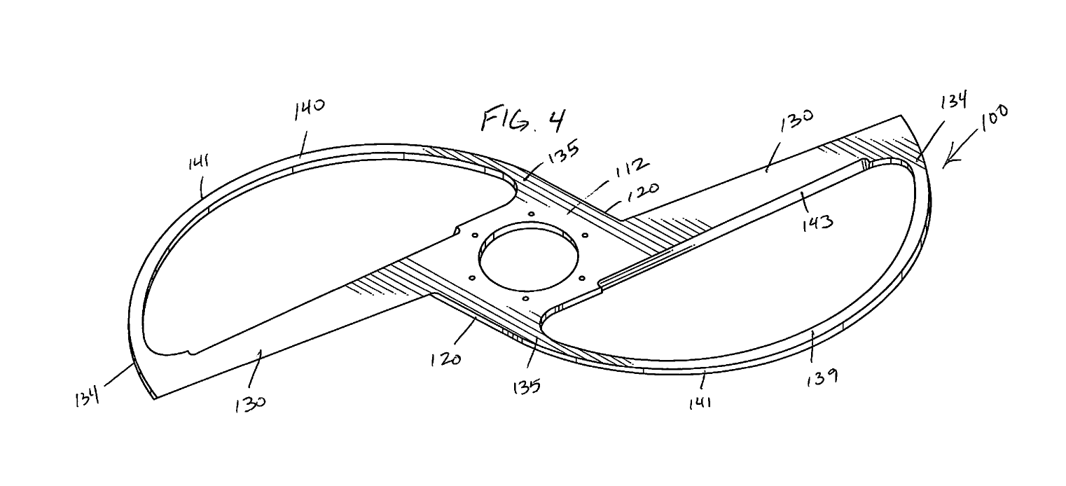

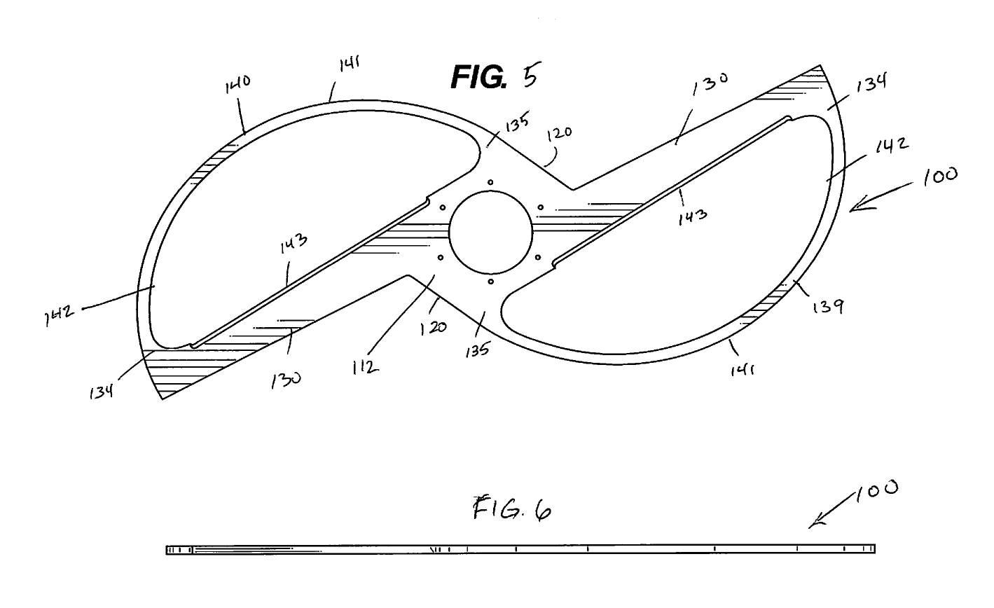

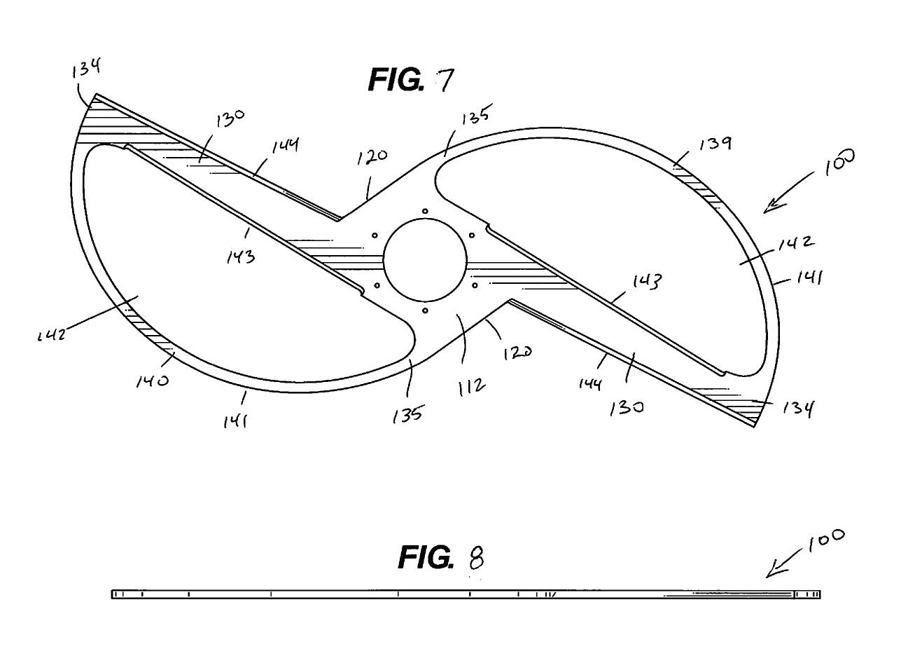

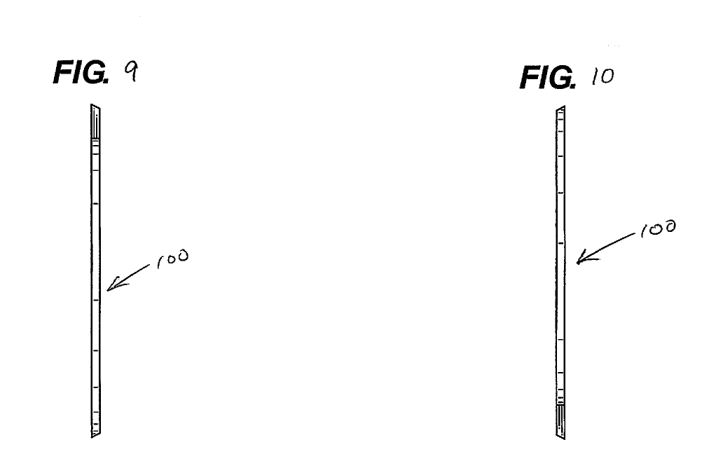

FIGS. 2 and 4-10 illustrate an alternate embodiment of the rib or fastening 100. The arched rib 100 is disposed on the shaft 3 through hub opening 122. Bolts (not shown) may be threadedly disposed in the respective threaded bores, the end of the respective bolts bearing on the exterior margin of the shaft 3 to fixedly couple the rib 100 to the shaft 3.

Rib 100 includes opposed flighting inner edge supports 120, which are preferably formed integral with the hub body 112. A selectable balancing mass [not shown] may be formed integral with the flighting inner edge support 120 or be attached independently. The selectable balancing mass preferably extends radially from the hub body 112. Other known means may be utilized to affect such mass, such as varying of the exterior margin of the balancing mass and forming the balancing mass of a material having a greater or less mass as desired, for example.

The rib 100 includes a rib arm 130 that extends radially outward from the hub 112. The rib arm 130 may include opposing arched wing 139 and 140 that connect to the rib 100 at a first end 135 approximate the inner edge support 120 at a second end proximate the distal end 134. The arched wings 139 and 140 maybe of a single piece or be constructed of multiple segments. The arched wings 139 and 140 allow for additional surface area in which to connect to the vane or flighting. The arched wings 139 and 140 have an outer face 141 that may be flat or contain connections for attaching the vanes. A wing aperture 142 is defined by the rib arm 130 and the arcuate wings 139 and 140. The wing aperture 142 is an inner region of the rib 100 that may be open or may be filled with other support structure. Rib arm 130 may also include a slanted inner face 143 and a slanted outer face 144. Rib arm inner face 143 and Rib arm outer face 144 may have a bevel, slant or curvature to increase the aerodynamic aspects of the rib. Likewise, rib arm 140 may have a concave or curved cross section.

As illustrated in FIG. 2, the individual ribs 100 may be disposed on the shaft 3. The flighting 2a, 2b may then be coupled to the individual ribs 100. The inner margin of flighting 2a is coupled to the outer face 141 of the ribs 139 and 140. The vanes may be comprised of strips or slats, rather than a single piece. The strip or slats are either in horizontal or vertical direction, or in any direction between 0 to 90 degrees angle.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

1. A rotor having at least two vanes and including a plurality of arched support ribs rigidly connecting at axially spaced intervals along a shaft;
each arched support rib including a hub section and an arched rib arm section, the hub section defining a connecting boss for connection to the shaft, and
wherein the vanes are connected to the arched rib arm section.

2. The rotor of claim 1 wherein the arched rib arm section includes an arched wing and a mounting arm.

3. The rotor of claim 2 wherein the vanes are mounted along an outer perimeter of the arched wing.

4. The rotor of claim 2 wherein the mounting arm includes a beveled face.

5. The rotor of claim 2 wherein the arched wing and the mounting arm define a wing aperture.

6. The rotor of claim 5 wherein the wing aperture includes structural cross supports.

7. The rotor of claim 3 wherein the vanes are glued or screwed to the outer perimeter of the arched wing.

8. The rotor of claim 1, the connecting boss including a threaded bore defined therein.

9. The rotor of claim 1 including an airfoil shaped portion being disposed intermediate the connecting boss and the balancing mass

10. The rotor of claim 1, wherein the vanes are made of strips or slats, which are either in horizontal or vertical direction, or in any direction between 0 to 90 degrees.

11. A method for mounting a vane to a rotor, the method comprising;
connecting an arched rib assembly transverse to a shaft, the arched rib assembly having a central hub defining an opening for engaging the shaft, the arched rib assembly including a rib arm extending radially from the hub and an arched wing connecting at a distal end of the rib arm with the hub, and
fastening an interior face of the vane to a mating face of the rib arcuate arm.

12. The method of claim 11 wherein fastening the vanes to the ribs includes glue or screws.

13. The method of claim 11, wherein the rib arm is made of a material different from a material forming the arched wing.

14. The method of claim 11, wherein the vanes are made of strips or slats, which are either in a horizontal or a vertical direction, or in any direction between 0 to 90 degrees.
